(19) United States
(12) Patent Application Publication
(10) Pub. No.: US 2006/0129762 A1
(43) Pub. Date: Jun. 15, 2006

(54) Accessible buffer for use in parallel with a filling cacheline

(75) Inventor: William V. Miller, Arlington, TX (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies, Inc.

(21) Appl. No.: 11/009,735

(22) Filed: Dec. 10, 2004

(51) Int. Cl. G06F 13/00

(52) U.S. Cl. 711/118

(57) ABSTRACT

A cache system, used in conjunction with a processor of a computer system, is disclosed herein for increasing the processor access speed. The cache system comprising a cache controller in communication with the processor and cache memory in communication with the cache controller. The cache memory comprising a number of cachelines for storing data, each cacheline having a predefined number of entries. The cache system further comprises a buffer system in communication with the cache controller. The buffer system comprising a number of registers, each register corresponding to one of the entries of a filling cacheline. Each respective register stores the same data that is being filled into the corresponding entry of the filling cacheline. Unlike the data in the filling cacheline, the data in the registers of the buffer system can be accessed during a cacheline filling process.

### TECHNICAL FIELD

In general, the present disclosure is directed to accessing data from memory in a processor-based system. More particularly, the present disclosure is directed to cache systems and allowing the access of data in cache memory while a cacheline is being filled to thereby increase the processor access speed.

### BACKGROUND

The demand on computer systems to quickly process, store, and retrieve large amounts of data and/or instructions continues to increase. One way to speed up a processor's access of stored data is to use cache memory for storing a duplicate copy of the data that the processor most recently retrieved from main memory. When the processor requests data that resides in the cache, the data can be retrieved much more quickly from cache than if the processor is required to retrieve the same data from main memory. Since software is typically written such that the same locations in memory are accessed over and over, it has been known in the art to incorporate some type of cache system in communication with the processor for speeding up the data access time by making the needed data more quickly accessible.

FIGS. 1 and 2 illustrate a conventional computer system 10, which includes a processor 12, main memory 14, and input/output (I/O) devices 16, each interconnected via an internal bus 18. The I/O devices 16 are well known in the art and will not be discussed herein. The processor 12 contains a cache system 20, which includes a cache controller 22 and cache 24. The cache 24 is a level 1 (L1), or primary, cache that may contain, for example, about 32 K bytes of synchronous random access memory (SRAM). The cache 24 is used as a temporary storage unit for storing a local copy of frequently-used or recently-used data, in anticipation that the processor 12 is likely to need this data again. The main memory 14 typically comprises dynamic random access memory (DRAM), which is usually less expensive than SRAM, but requires more time to access since the speed of accessing data in main memory 14 is limited by the bus clock, which is typically several times slower than the processor clock. For this reason, it is beneficial to utilize the cache 24 whenever possible.

The cache controller 22 is configured to be connected in the cache system 20 so as to control the operations associated with the cache 24. When the processor 12 requests to access data from main memory 14, the cache controller 22 first checks to see if the data is already in the cache 24. If it is, then this access is considered a “cache hit” and the data can be quickly retrieved from the cache 24. If the data is not in the cache 24, then the result is a “cache miss” and the processor 12 will have to request the data from main memory 14 and store a copy of the data in the cache 24 for possible use at a later time.

FIG. 3 is a diagram showing a representation of how a conventional cache 24 may be organized. The cache 24 is configured as a cache array having a number of “cachelines” 26, illustrated in this figure as columns. The cache array may have, for example, about 1024 cachelines. Each cacheline 26 has a predefined number of entries 28. Although the example of FIG. 3 shows the cachelines 26 with eight entries 28, the cachelines 26 may be designed to have 4, 8, 16, or any suitable number of entries 28. A “cacheline” as described herein refers to a unit or block of data which is fetched from sequential addresses in main memory 14, wherein each respective cacheline entry 28 stores the data from one of these corresponding memory addresses. Each cacheline is configured to have a predefined width, which, for example, may be 8, 16, 32, or any suitable number of bits. Therefore, the width of the cacheline also defines the number of bits that are stored for each entry 28.

The operation of the cache controller 22 will now be described. When the processor makes a memory access request, the cache controller 22 determines whether the access is a cache miss or a cache hit. For a cache miss, the cache controller 22 allocates a cacheline in the cache array to be filled. Before filling a cacheline 26, however, the cache controller first invalidates the cacheline 26 since the data being filled cannot be accessed until the entire cacheline 26 is filled. Then the cache controller 22 retrieves data from main memory 14 and fills the cacheline 26 one entry at a time to replace the old values in the cacheline 26. The cache controller 22 retrieves data not only from the one location being requested, but also from a series of sequential memory locations. This is typically done in anticipation of the processor 12 possibly needing the data from these additional locations as well. For example, with a cacheline having eight entries, a request to address 200 will cause the cache controller to fill the data from addresses 200 through 207 into the respective entries 28 of the cacheline 26. When data is written to the cache 24, it is written into one entry 28 at a time until that cacheline 26 is completely filled. After completely filling the cacheline 26, the cache controller 22 validates the filled cacheline 26 to indicate that data can then be accessed therefrom. One valid bit is used per cacheline 26 to indicate the validity of that cacheline 26.

A problem with the conventional cache system 20, however, is that when the processor 12 requests access to data in a filling cacheline, this request is neither a cache hit nor a cache miss. It is not considered a cache hit because the filling cacheline is flagged as invalid while it is filling. Therefore, this situation is handled differently than for a cache hit or cache miss. In this situation, the cache controller 22 asserts a wait signal for “waiting the processor”, or, in other words, causing the processor to wait, for the amount of time necessary for the cacheline to be filled and validated. Then, the access to the filled cacheline will hit in the cache and the data can be retrieved.

FIG. 4 illustrates a simple flowchart 30 of the operation of the conventional cache controller 22 of the cache system 20 when a data access is requested. In decision block 32, it is determined whether or not a new request is a cache hit, or, in other words, hits in the cache. If not, then flow is directed to block 34 in which case the cache controller waits the processor and fills the entire cacheline with the requested data from main memory 14. All subsequent access requests to the filling cacheline will be stalled behind the waited processor.

If the request in decision block 32 hits in the cache, then the data in cache can be accessed. In this case, flow is directed to decision block 36 where it is determined whether the request is a read or a write. For a read request, flow goes to block 38, but if the request is a write, then flow goes to block 40. In block 38, the data can be immediately read from cache and the processor resumes operation with its next instructions. In block 40, a process for writing data into the cache begins. In this writing process, data to be stored is written to cache and can be written to main memory at the same time or, alternatively, data can be written to main memory after the write-to-cache operation.

As can be seen from the flowchart of FIG. 4, unless the request hits in the cache (block 32), the processor is forced to wait, thereby holding up the processor from working on other operations. Although this method is quite simple, it provides the worse possible processor waiting times for a cache system. Aware of the fact that the processor wait times will be high, those skilled in the art have attempted to design cache systems that address this issue.

FIG. 5 illustrates a flowchart 42 of the operation of a cache controller that improves upon the operation described with respect to FIG. 4. In flowchart 42, blocks 32, 36, 38, and 40 are the same as in FIG. 4 for the condition when the request hits in the cache. Since the processor is not stalled in this situation anyway, this portion of the flowchart 42 can remain the same.

However, it should be evident that flowchart 42 of FIG. 5 differs from FIG. 4 for the condition when the request does not hit in the cache in decision block 32. In this case, when it does not hit in the cache, flow is directed to decision block 44, which determines whether or not the request hits in a cacheline that is in the process of being filled. If not, then flow proceeds to block 46. Block 46 is performed when the request does not hit in the cache or in the filling cacheline, or in other words, when it must be retrieved from main memory. In this case, the cache controller requests the desired data from main memory by waiting the processor behind the cacheline fill process of a currently filling cacheline and then beginning the process of filling a new cacheline. The filling process continues until the requested location in the new cacheline is filled. When the requested location is filled, the data will also be fed back (block 56) to the processor if the request is determined to be a read in decision block 48. After the read data is fed back to the processor in block 56, the processor may perform additional operations in parallel with the process of filling the remaining portion of the new cacheline.

If it is determined in block 44 that the request does hit in the filling cacheline, then the flow proceeds to decision block 50, which determines whether or not the data access request is made for a location (entry) in the cacheline that has already been filled. If block 50 determines that the location has not yet been filled, then flow is directed to block 52, where the processor is waited and the filling process is continued for the filling cacheline until the location is filled. When the requested location is filled, the data will also be fed back to the processor (block 56) if the request is determined to be a read in decision block 48. If it is determined in block 50 that the location in the filling cacheline has already been filled, then flow is directed to block 54.

In block 48, it is determined whether or not the request is a read or a write. For a write, the flow proceeds to block 54, but for a read, the flow proceeds to block 56. In block 54, the processor is waited until the entire cacheline is filled. After the cacheline is filled, the process flow continues on to block 36, where the steps mentioned above with respect to FIG. 4 are performed.

Even though FIG. 5 is an improvement over the process of FIG. 4, it still includes several processor wait times, which essentially slows the processor down. It would therefore be beneficial to eliminate even more of these processor wait times in order to improve the processor's performance. By improving upon the conventional cache system, it would be possible to further increase the processor data access speed.

### SUMMARY

Cache systems and methods associated with cache controlling, described in the present disclosure, provide improvements to the performance of a processor by allowing the processor to access data at an increased speed. One embodiment of a cache system according to the teaching of the present disclosure comprises a cache controller that is in communication with a processor and cache memory that is in communication with the cache controller. The cache memory comprises a number of cachelines for storing data, wherein each cacheline has a number of entries. The cache system further includes a buffer system that is in communication with the cache controller. The buffer system comprises a number of registers, wherein each register corresponds to one of the entries of a filling cacheline. Each respective register stores the same data that is being filled into the corresponding entry of the filling cacheline. The cache controller of the cache system is configured to store the same data in both the filling cacheline and in the registers of the buffer system. During a cacheline fill process, the data in the registers of the buffer system can be accessed even though the valid bit associated with the filling cacheline indicates it is invalid.

### BRIEF DESCRIPTION OF THE DRAWINGS

Many aspects of the embodiments of the present disclosure can be better understood with reference to the following drawings. It can be noted that like reference numerals designate corresponding parts throughout the drawings.

FIG. 1 is a block diagram showing a conventional computer system.

FIG. 2 is a block diagram illustrating the conventional cache system shown in FIG. 1.

FIG. 3 is a graphical representation of a conventional cache array.

FIG. 4 is a flowchart illustrating a first operational process of the conventional cache system of FIG. 2.

FIG. 5 is a flowchart illustrating a second operational process of the conventional cache system of FIG. 2.

FIGS. 6 and 7 are block diagrams of embodiments of cache systems according to the teachings of the present disclosure.

FIG. 8 is an embodiment of the buffer system shown in FIGS. 6 and 7.

FIG. 9 is an embodiment of the buffer hit detecting module shown in FIG. 8.

FIG. 10 is an embodiment of the buffer location validating module shown in FIG. 8.

FIG. 11 is an embodiment of the cacheline fill buffer shown in FIG. 8.

FIG. 12 is an embodiment of a logic representation illustrating an output response of the write controlling module shown in FIG. 8.

FIG. 13 is a flowchart illustrating the operational process of the cache controller shown in FIGS. 6 and 7.

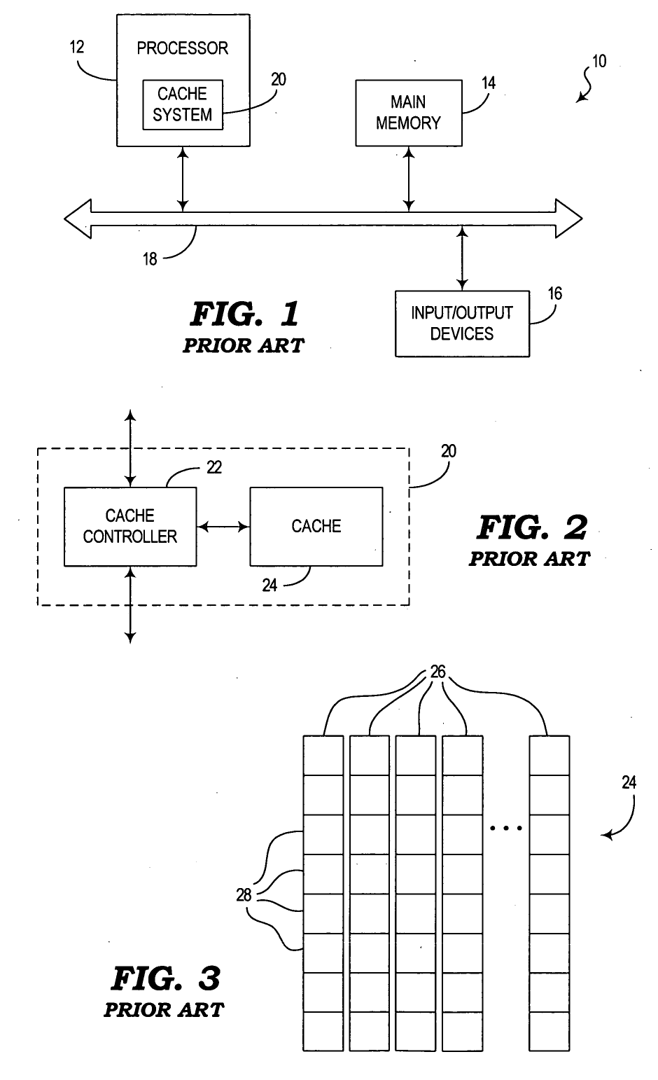

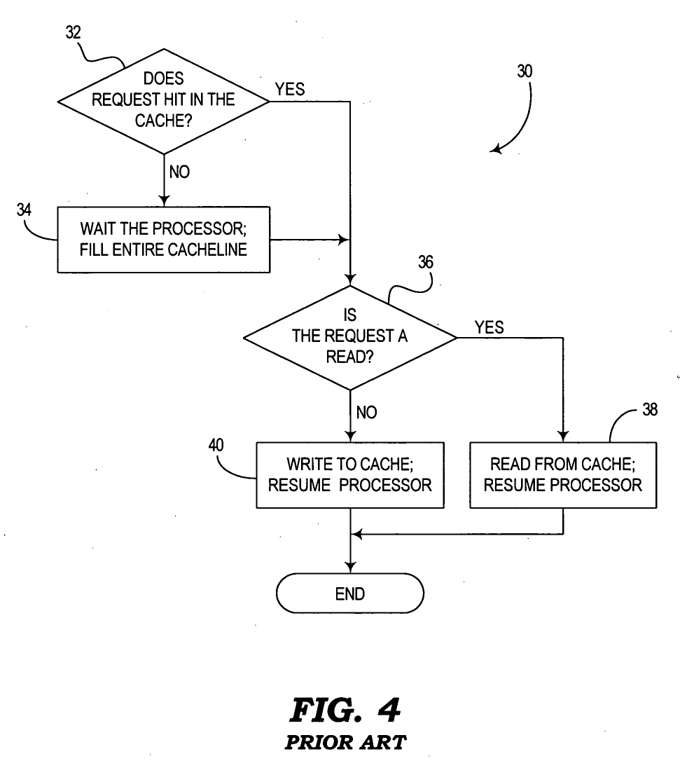

### DETAILED DESCRIPTION

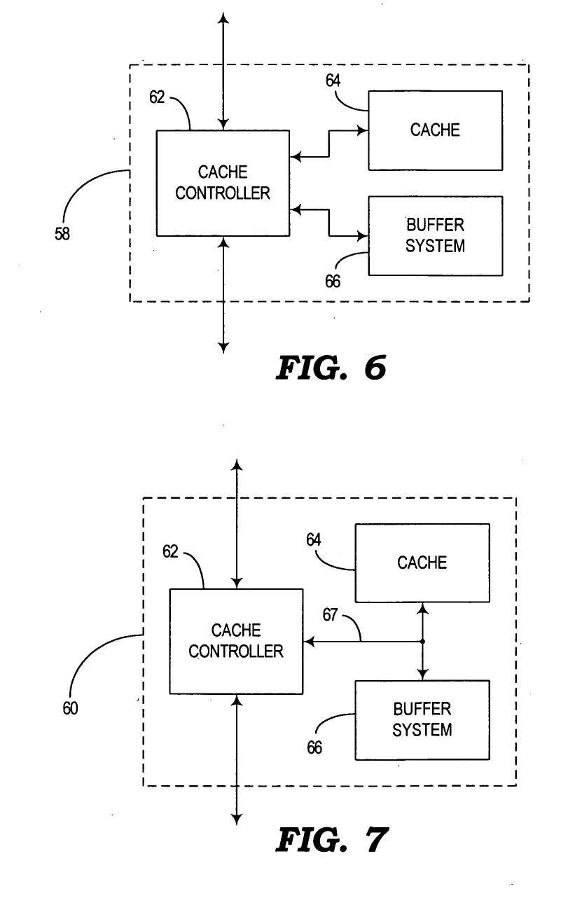

FIGS. 6 and 7 are block diagrams illustrating embodiments of cache systems 58, 60 in accordance with the teachings of the present disclosure. In contrast to the conventional cache system of FIG. 2, which merely includes a cache controller and cache, the cache systems shown in FIGS. 6 and 7 include additional buffer systems for storing, in parallel, the data being filled into a filling cacheline. The cache systems 58, 60 include a cache controller 62, cache 64, and a buffer system 66. The cache controller 62 is in communication with the processor and also in communication with main memory via an internal bus. Not only does the cache controller 62 control the data transfers with respect to the cache 64, but it also controls the data transfers with respect to the buffer system 66.

The cache system 58 of FIG. 6 differs from the cache system 60 of FIG. 7 by the way in which the cache controller 62 communicates with the cache 64 and buffer system 66. In FIG. 6, the cache controller 62 communicates with these elements along separate communication paths. In FIG. 7, the cache controller 62 communicates with the elements along a common bus 67. In both embodiments, when an access request hits in the cache 64, the cache controller 62 can write data into the cache 64 and read data from the cache 64 in a typical manner. In addition, however, the cache controller 62 also writes the same data that is being written into a filling cacheline of the cache 64 into the buffer system 66 as well. When the cache controller 62 determines that data is in the cache 64 but cannot be accessed because the data is in a cacheline that is in the process of being filled, then the cache controller 62 will instead access the duplicate data in the buffer system 66, which acts as an accessible storage unit for a filling cacheline.

When the processor requests a write to a cache location that hits in a filling cacheline, the cache controller 62 writes the data into the buffer system 66 and allows this data to be written to cache 64 when the rest of the cacheline has been filled. Thus, with the updated data written into the buffer system 66, if the processor makes a subsequent read request of that location prior to the completion of the cacheline fill, then the cache controller 62 will read the appropriate value out of the buffer system 66.

The buffer system 66 stores the data in accessible registers while the same data is being filled into the cacheline. By storing a duplicate copy of the data in the buffer registers, the buffer system 66 allows data to be accessed without interrupting the filling cacheline or causing undesirable processor waiting times. Since the buffer system 66 stores a copy of the data that is also being filled in the filling cacheline, there will actually be three copies of this data—the data that is stored in main memory, the data being filled in the cacheline, and the data stored in the buffer system 66. Since data in the filling cacheline cannot always be accessed, as explained above, and the data in main memory takes a relatively long time to access, the buffer system 66 in these embodiments is capable of being accessed at the faster processor speed while the cacheline fill process is going on. Therefore, for accesses of data in a filling cacheline, these embodiments allow access to this same data in the buffer to free up the processor and allow it to move on to its next instructions, thereby increasing the operational speed of the processor.

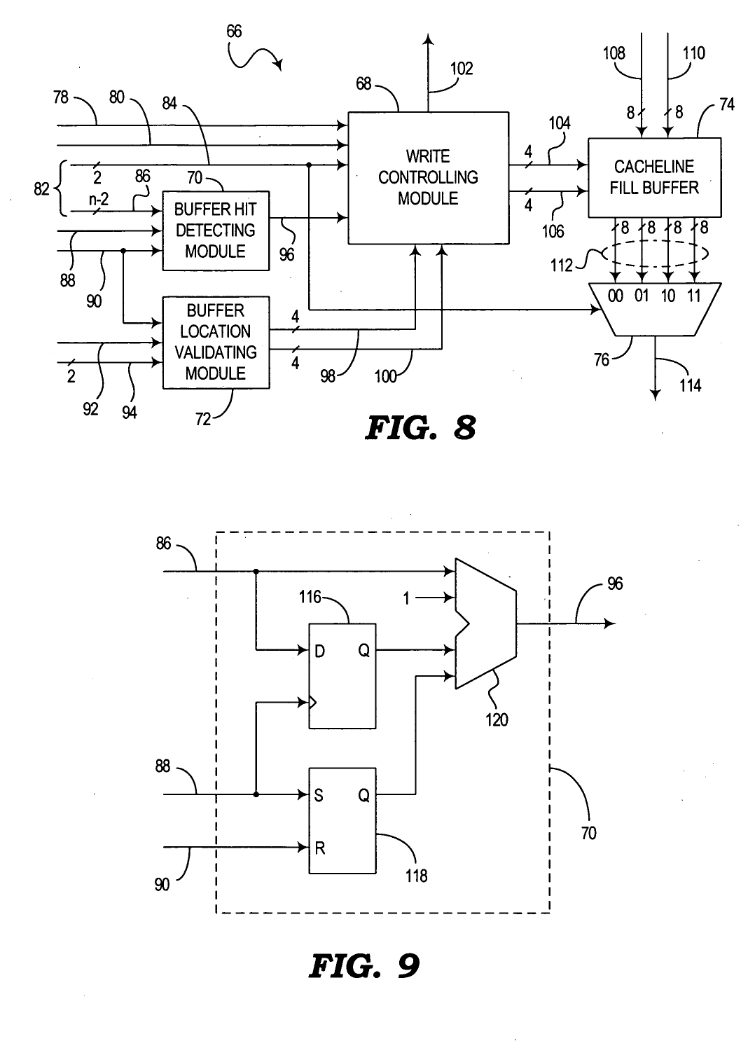

FIG. 8 is a block diagram of an embodiment of the buffer system 66 shown in FIGS. 6 and 7. The buffer system 66 in this embodiment includes a write controlling module 68, a buffer hit detecting module 70, a buffer location validating module 72, a cacheline fill buffer 74, and a multiplexer 76. The buffer system 66 may be designed such that the multiplexer 76 is replaced by a set of multiplexers for selecting the desired data values from the cacheline fill buffer 74. The write controlling module 68 contains any suitable combination of logic elements for decoding input signals and providing the appropriate responses as described herein. Also, as an alternative embodiment, the elements 68, 70, and 72 of the buffer system 66 may be included as part of the cache controller 62 if desired.

In this example illustrated in FIG. 8 and in the following figures, the buffer system 66 is designed to operate in parallel with a cache 64 having cachelines that are one-byte wide and four entries deep. However, it should be noted that the design of the buffer system 66 may be altered to operate with caches of any width and any number of entries. One of ordinary skill in the art, having read and understood the present disclosure, will recognize the applicability of the buffer system 66 to caches of any size and would not be limited by the specific embodiments discussed herein.

The write controlling module 68 is configured to receive a “processor_read” signal along line 78 and a “processor_write” signal along line 80. These signals are sent from the processor to indicate whether the request is a read request or a write request. Also, the buffer system 66 receives from the processor an “address” signal 82, corresponding to the address of the requested data as stored either in main memory or in the cache 64. The address signal 82, having a number of bits n, is input such that the least significant 0 and 1 bits of the address (address [1:0]) are input into the write controlling module 68 along lines 84 and the third through nth least significant bits (address [n:2]) are input into the buffer hit detecting module 70 along lines 86.

The buffer hit detecting module 70 is further configured to receive a “begin_fill” bit along line 88 and a “validate_cacheline” bit along line 90. The begin_fill bit indicates the start of the cacheline filling process and will remain high until the cacheline is completely filled. The validate_cacheline bit indicates whether or not the cacheline has been completely filled. If so, then the cacheline is indicated to be valid by a high validate_cacheline bit. If the cacheline is still in the process of being filled, then the validate_cacheline bit will be low to indicate that the cacheline is not yet valid. The cache controller 62 checks to see if data in the cacheline can be accessed based on whether the requested cacheline has been validated. The buffer hit detecting module 70 outputs a “buffer_hit” bit along line 96 to the write controlling module 68 for indicating when a request hits in the filling cacheline and consequently also hits in the cacheline fill buffer 74.

The validate_cacheline bit along line 90 is also input into the buffer location validating module 72. In addition to indicating the validity of the filling cacheline, the validate_cacheline bit also indicates whether or not the cacheline fill buffer 74 is valid or invalid, since the cacheline fill buffer 74 will be valid during the cacheline fill process when the filling cacheline itself is not valid. Therefore, either the cacheline itself, when completely filled, will indicate it is valid or the cacheline fill buffer 74, during cacheline filling, will indicate it is valid, but not both. A high validate_cacheline bit can therefore be used as a reset signal to invalidate the cacheline fill buffer 74.

Furthermore, the buffer location validating module 72 is configured to receive a “fill_cache_write” bit along line 92 and a two-bit “cache array address [1:0]” signal along line 94. The buffer location validating module 72 outputs four “validate_offset” bits along lines 98 and four “offset_valid” bits along lines 100 to the write controlling module 68, as described in more detail below. The write controlling module 68 outputs a “processor_read_buffer_hit” bit along line 102 for indicating when a processor read request hits in the cacheline fill buffer 74. Also, the write controlling module 68 outputs four “processor_write_offset” bits along lines 104 and four “register_offset_write” bits along lines 106 to the cacheline fill buffer 74. These signals are also described in more detail below.

In addition to the signals along lines 104 and 106, the cacheline fill buffer 74 also receives an eight-bit “fill_write_data [7:0]” signal along lines 108 and an eight-bit “processor_write_data [7:0]” signal along lines 110. The cacheline fill buffer 74 outputs four eight-bit “register_offset [7:0]” signals along lines 112 to the multiplexer 76, which also receives the processor_address [1:0] signal along line 84. The multiplexer 76 includes four inputs 00, 01, 10, and 11 for receiving the signals along lines 112 and a selection input for receiving the processor_address [1:0] signal from line 84. The multiplexer 76 outputs a “buffer_read_data [7:0]” signal along line 114 at the output of the buffer system 66, representing the data that the processor requested, the data of which, as may be unknown to the processor, was being stored in the cacheline fill buffer 74.

FIG. 9 is an embodiment of the buffer hit detecting module 70 shown in FIG. 8. The buffer hit detecting module 70 detects which cacheline is being filled and determines whether a request is made to that filling cacheline, in which case the request would hit in the cacheline fill buffer 74. The buffer hit detecting module 70 in this embodiment comprises a first flip-flop 116, a second flip-flop 118, and a comparator 120. In one embodiment, the first flip-flop 116 may comprise a D-type flip-flop or other suitable flip-flop circuit. The second flip-flop 118 may comprise a set-reset flip-flop, D-type flip-flop, or other suitable flip-flop circuit. However, as will be understood by one of ordinary skill in the art, the buffer hit detecting module 70 may be configured using other logic components for performing substantially the same function as mentioned herein. As mentioned above, the buffer hit detecting module 70 receives address [n:2], begin_fill, and validate_cacheline signals from lines 86, 88, and 90, respectively, and supplies the buffer_hit bit along line 96 to the write controlling module 68 when a request is made to the filling cacheline, thereby activating the buffer system 66 of the present disclosure.

When the begin_fill bit along line 88 is high, indicating that the cacheline has begun filling, and the validate_cacheline bit is low, indicating firstly that the cacheline is in the process of filling and is not validated and secondly that the cacheline fill buffer 74 is active, then the output of flip-flop 118 will be high. At this time, it will be known that the cacheline is filling and not yet complete, therefore indicating that the cacheline fill buffer 74 is valid. The high begin_fill bit along line 88 clocks the flip-flop 116 to output the address [n:2] signal to the comparator 120. The comparator 120 detects when the top signals are equal to the bottom signals and at that time outputs a high buffer_hit signal along line 96 to indicate that a request to access data hits in the filling cacheline and can actually be accessed from the cacheline fill buffer 74. This buffer_hit bit is sent to the write controlling module 68 for further processing as is described below.

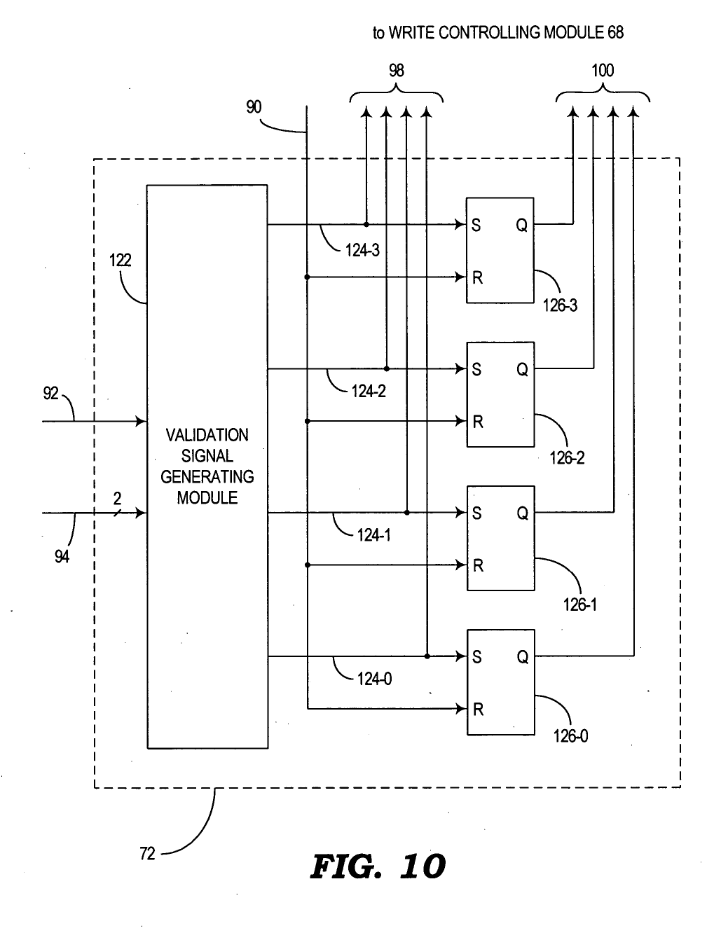

FIG. 10 is an embodiment of the buffer location validating module 72 as shown in FIG. 8. The buffer location validating module 72 determines which location (address) in the filling cacheline is in the process of being filled and which locations have already been filled. As mentioned above, these locations in the filling cacheline correspond to the respective locations (registers) in the cacheline fill buffer 74. As will become more evident from the description below, a filled location in the cacheline fill buffer 74 is a valid location.

The buffer location validating module 72, according to this embodiment, includes a validation signal generating module 122 and four flip-flops 126-0, 126-1, 126-2, 126-3. In other embodiments, the buffer location validating module 72 may be designed to include any combination of logic and/or discrete elements to perform substantially similar functions as described herein. The flip-flops 126 essentially operate as set-reset flip-flops but, for example, may comprise D-type flip-flops and accompanying logic components. It should be recognized that the number of flip-flops 126 depends upon the number of entries in the cacheline, wherein each flip-flop 126 corresponds to an entry in the cacheline for indicating which entries are being or have been filled. Also, the validation signal generating module 122 contains any suitable combination of logic components for decoding the input signals along lines 92 and 94 and providing the appropriate responses along lines 124.

During operation of the buffer location validating module 72, the validate_cacheline signal along line 90 will be low, indicating that the cacheline is still filling and is not validated, but, on the other hand, that the cacheline fill buffer 74 is valid. At this time, access requests to the filling cacheline will hit in the cacheline fill buffer 74. When the cacheline is completely filled, and the validate_cacheline signal goes high to indicate that the cacheline is validated, then the flip-flops 126 are reset, and all of the outputs along lines 100 will be low to indicate that none of the locations in the cacheline fill buffer 74 are valid. At this time, however, access requests to the cacheline will hit in the completely filled cacheline and the cacheline fill buffer 74 is therefore not needed in this case. The cacheline fill buffer 74 will therefore be flagged as invalid for the completely filled cacheline and can be used in parallel with another cacheline to be filled.

The validation signal generating module 122 receives the fill_cache_write signal along line 92 and the two-bit address [1:0] signal along line 94. These signals are received from the cache controller 62 indicating that the requested data is currently filling the location in the cacheline corresponding to address [1:0]. In this example, there are four entries, which therefore requires two bits to address the four possible registers corresponding to the four entries in the cacheline. This address may be used to designate an “offset” for identifying the registers in the cacheline fill buffer 74. For example, in this embodiment, the offset is used to identify one of the four registers to indicate the stage of the cacheline filling routine.

The validation signal generating module 122 outputs validate_offset bits along lines 124-0, 124-1, 124-2, and 124-3 to the “set” inputs of respective flip-flops 126. These bits are also transmitted along lines 98 leading to the write controlling module 68. The validate_offset bits indicate which one of the registers in the cacheline fill buffer 74, and the corresponding entry in the cacheline of the cache array, is currently in the process of being filled. A validate_offset_{—}0 bit is sent along line 124-0 to flip-flop 126-0 to indicate that the zero offset register in the cacheline fill buffer 74 is being filled and validate; a validate_offset_{—}1 bit is sent along line 124-1 to flip-flop 126-1; a validate_offset_{—}2 bit is sent along line 124-2 to flip-flop 126-2; and a validate_offset_{—}3 bit is sent along line 124-3 to flip-flop 126-3. The validation signal generating module 122 outputs these validate_offset bits according to the truth table shown below:

| | | Active (logic 1) |
|---|---|---|
| Input Signals | | validate_offset |
| fill_cache_write | cache_array_address[1:0] | signals |
| (line 92) | (line 94) | (lines 124) |
| 1 | 00 | validate_offset_0 |
| 1 | 01 | validate_offset_1 |
| 1 | 10 | validate_offset_2 |
| 1 | 11 | validate_offset_3 |

| | |
|---|---|
| All Other Cases | not active (logic 0) |

The flip-flops 126 are set with the respective validate_offset bits and can be reset by the validate_cacheline bit along line 90. The output of the flip-flops 126 is referred to herein as offset_valid bits, which are sent along lines 100 to the write controlling module 68 shown in FIG. 8. When a validate_offset bit is received along line 124, the signal at the output of the respective flip-flop 126 will be set high to indicate that the corresponding register in the cacheline fill buffer 74 has already been filled and is valid. This signal remains high until the flip-flops 126 are reset by the reset signal along line 90.

In contrast to the prior art which merely determines whether the entire cacheline is valid, these offset_valid bits indicate which entries stored in the cacheline fill buffer are valid. The term “offset” used herein refers to the location of the registers in the cacheline fill buffer 74, wherein a zero offset refers to the register location corresponding to the actual requested address from main memory. Also, for example, if address 200 were requested, then the register corresponding to address 200 has a “0” offset. The register corresponding to address 201 has an offset of “1”; the resister corresponding to address 202 has an offset of “2”; and the register corresponding to address 203 has an offset of “3”. Therefore, a high offset_valid bit along one or more of lines 100 is used as a flag to indicate that these corresponding offset registers in the cacheline fill buffer 74 are valid.

As an alternative to using an offset_valid bit for each register in the cacheline fill buffer 74, the cache 64 itself may be configured such that there is a valid bit for each entry in each cacheline. However, since the cache 64 may have on the order of about 1024 cachelines, the number of valid bits would be very great. Assuming that there are 1024 cacheline and each cacheline includes 8 entries, then 8192 valid bits would be required to indicate the validity of each entry in such a cache. Of course, caches of greater size would require even more entry valid bits. Although this alternative embodiment is feasible, the use of the cacheline fill buffer as described herein requires only 1032 valid bits for the above example of a cache with 1024 eight-entry cachelines, whereby one valid bit is used for each of the eight entries of the filling cacheline and one valid bit is used for the already-filled validated cachelines that are not in the process of filling. Therefore, the embodiments of FIGS. 6 and 7 including the buffer system 66 would be preferable to this alternative embodiment.

Reference is made again to FIG. 8, in which the write controlling module 68, in response to the offset_valid bits along lines 100 and other previously mentioned signals, outputs processor_write_offset bits along lines 104. The processor_write_offset bits are forwarded to the cacheline fill buffer 74 to coordinate the timing in which each source provides data to the cacheline fill buffer 74. Input signals are decoded by the write controlling module 68 to provide the processor_write_offset bits according to the following truth tables:

| Input Signals | | | | processor_{—} |
|---|---|---|---|---|
| processor_{—} | | | | write_{—} |
| write | address [1:0] | offset_valid_0 | buffer_hit | offset_0 |
| (line 80) | (line 84) | (line 100) | (line 96) | (line 104) |
| 1 | 00 | 1 | 1 | 1 |

| | |
|---|---|
| All Other Cases | 0 |

| Input Signals | | | | processor_{—} |
|---|---|---|---|---|
| processor_{—} | | | | write_{—} |
| write | address [1:0] | offset_valid_1 | buffer_hit | offset_1 |
| (line 80) | (line 84) | (line 100) | (line 96) | (line 104) |
| 1 | 01 | 1 | 1 | 1 |

| | |
|---|---|
| All Other Cases | 0 |

| Input Signals | | | | processor_{—} |
|---|---|---|---|---|
| processor_{—} | | | | write_{—} |
| write | address [1:0] | offset_valid_2 | buffer_hit | offset_2 |
| (line 80) | (line 84) | (line 100) | (line 96) | (line 104) |
| 1 | 10 | 1 | 1 | 1 |

| | |
|---|---|
| All Other Cases | 0 |

| Input Signals | | | | processor_{—} |
|---|---|---|---|---|
| processor_{—} | | | | write_{—} |
| write | address [1:0] | offset_valid_3 | buffer_hit | offset_3 |
| (line 80) | (line 84) | (line 100) | (line 96) | (line 104) |
| 1 | 11 | 1 | 1 | 1 |

| | |
|---|---|
| All Other Cases | 0 |

Still referring to FIG. 8, the write controlling module 68 provides a processor_read_buffer_hit signal along line 102, which is fed back to the cache controller 62 to indicate if the cacheline fill buffer 74 presently contains the read data that the processor is requesting. The state of the processor_read_buffer_hit signal is determined according to the following truth table:

| | | | | | | | Output |
|---|---|---|---|---|---|---|---|
| | | | | | | | along |
| Input Signals Along Lines . . . | | | | | | | line |
| 78 | 84 | 100-0 | 100-1 | 100-2 | 100-3 | 96 | 102 |
| 1 | 00 | 1 | X | X | X | 1 | 1 |
| 1 | 01 | X | 1 | X | X | 1 | 1 |
| 1 | 10 | X | X | 1 | X | 1 | 1 |
| 1 | 11 | X | X | X | 1 | 1 | 1 |

| | |
|---|---|
| All Other Cases | 0 |

FIG. 11 is an embodiment of the cacheline fill buffer 74 shown in FIG. 8, wherein the cacheline fill buffer 74 includes buffers or registers for storing in parallel the same data that is being filling into the filling cacheline. In this embodiment, the cacheline fill buffer 74 includes four multiplexers 128-0, 128-1, 128-2, and 128-3 and four registers 130-0, 130-1, 130-2, and 130-3. Four of each are included to correspond to the number of entries in the cacheline, e.g. four entries in this example, where each register 130 is configured to store one byte, which represents the width of the cacheline. It should be noted, however, that the circuitry can be expanded to include more or fewer than four of each of the multiplexers and registers if the cache is designed with more entries. Also, if the cacheline has a width different than one byte (eight bits), then the cacheline fill buffer 74 may be configured with multiplexers and registers each capable of handling larger entry sizes. Each multiplexer 128 receives at its “0” input the eight-bit fill_write_data signal along lines 108, which is the data from main memory used to fill a cacheline during a read request. Also, each multiplexer 128 receives at its “1” input the eight-bit processor_write_data signal along lines 110, which is the data in the processor to be written into memory during a write request.

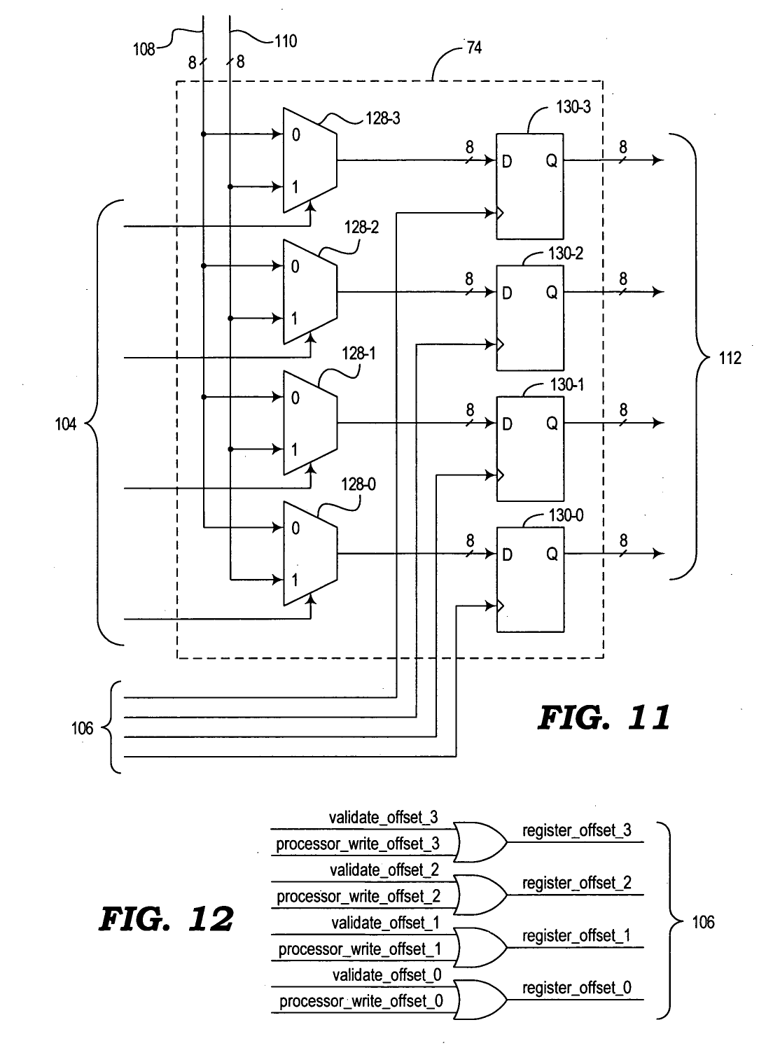

Selection inputs to the multiplexers 128 are connected to lines 104, which carry the processsor_write_offset signals as described with reference to the truth tables above. These signals select whether data to be stored in the cacheline fill buffer 74 is received from the main memory or from the processor. The selected output from each multiplexer 128 is provided to the corresponding register 130, shown here as D-type flip-flops. The registers 130 also receive the register_offset_write bits from the write controlling module 68 along lines 106 at a clock input thereof. The register_offset_write bits are output from the write controlling module 68 according to the logic shown in FIG. 12, in which the validate_offset bits are ORed with the respective processor_write_offset bits. The outputs from the registers 130 are provided as the eight-bit register_offset signals that are sent along lines 112 to the multiplexer 76 shown in FIG. 8. The register_offset signals represent the actual data stored in the registers 130, which also corresponds to the data being written to the filling cacheline.

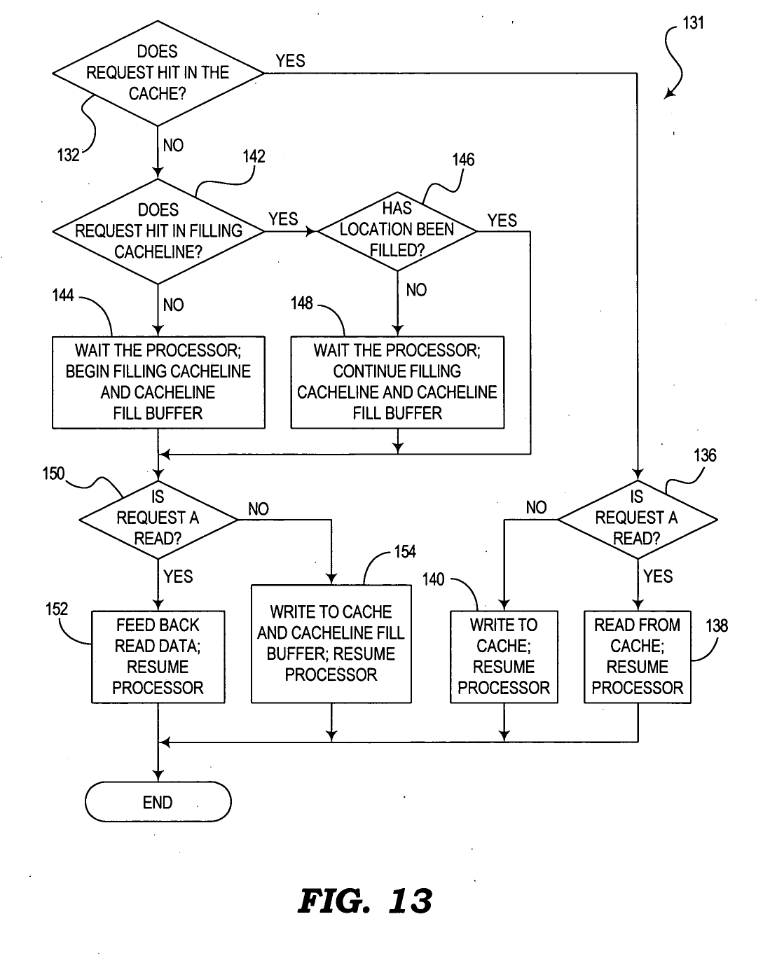

FIG. 13 is a flowchart 131 illustrating an example of the operation of the cache systems 58, 60 of FIGS. 6 and 7. The flowchart 131 begins with decision block 132, in which it is determined whether or not a data request hits in the cache. If so, then the process flow proceeds to decision block 136, which determines whether the request is a read or a write. For a read request, flow proceeds to block 138 where the processor reads from cache and is allowed to resume operation on its next instructions. For a write, flow proceeds to block 140 where the processor writes to the cache and resumes other operations.

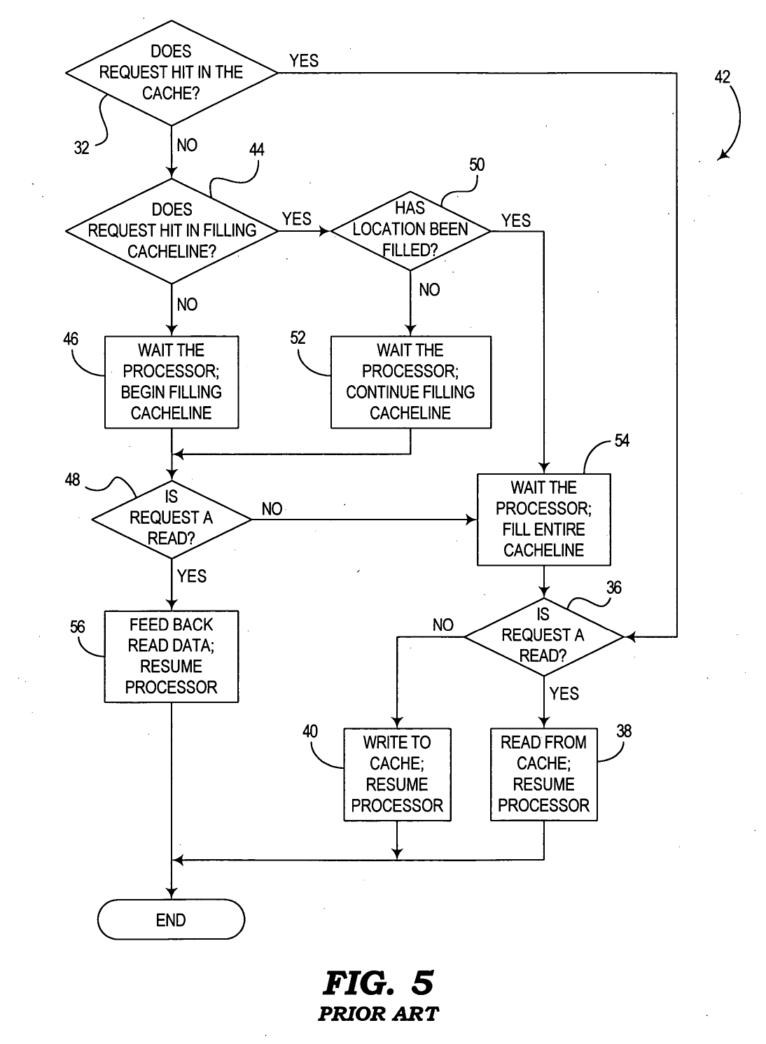

If the decision in block 132 determines that the request was a cache miss, then flow proceeds to decision block 142, where it is determined whether or not the request hits in the filling cacheline. If not, flow proceeds to block 144, and if so, then flow proceeds to decision block 146. In block 144, since the request does not hit in the cache or in a filling cacheline, then the processor is waited while the cacheline fill process begins. In contrast to FIG. 5, block 144 not only begins filling the new cacheline, but also begins filling the same data into the cacheline fill buffer in parallel with the filling of the cacheline. When the requested location in the cacheline is filled, the flowchart proceeds to block 150. In block 150, it is determined whether the request is a read or a write. If it is a read command, flow proceeds to block 152, where the read data can be fed back immediately without delay and the processor can resume with other operations. If the request in block 150 is determined to be a write, then flow proceeds to block 154, where the cache controller is allowed to write data to both the cache and the cacheline fill buffer.

In decision block 146, it is determined whether or not the access request is made to a location that has already been filled in the filling cacheline. If not, flow proceeds to block 148, and, if so, then flow proceeds to decision block 150. In block 148, when the request hits in the filling cacheline but the specific location in the cacheline has not yet been filled, then the processor is waited while the cacheline and cacheline fill buffer continue to fill. The filling process in block 148 continues until the location in the cacheline fill buffer is filled. At this point, the flowchart proceeds to block 150. Also in block 154, the processor resumes, enabling it to make another data request if necessary, even a request to access, data in the partially filled cacheline as recorded in the cacheline fill buffer and even a request to read the data stored in the cacheline fill buffer during the previous write request.

As can be seen from FIG. 13, the processor is not required to experience the same lengthy wait times as with the conventional systems. Instead, by utilizing the cache systems 58, 60 described herein, in which an accessible cacheline fill buffer records the same data as the filling cacheline, the performance of the processor can be improved by allowing the processor to access data in a partially filled cacheline during a read or write request. These accesses, as mentioned herein, are not processed by the filling cacheline itself but by the cacheline fill buffer, the registers of which can be just as quickly accessible as the cache itself. Allowing such accesses thereby increases the access speed of the processor.

It should be emphasized that the above-described embodiments of the present application are merely possible examples of implementations that have been set forth for a clear understanding of the principles of the invention. Many variations and modifications may be made to the above-described embodiments without departing substantially from the spirit and principles of the invention. All such modifications and variations are intended to be included herein within the scope of this disclosure and protected by the following claims.

I claim:

1. A cache system comprising:
a cache controller in communication with a processor;
cache memory in communication with the cache controller, the cache memory comprising a number of cachelines for storing data, each cacheline having a number of entries; and
a buffer system in communication with the cache controller, the buffer system comprising a number of registers, each register corresponding to one of the entries of a filling cacheline, each respective register storing the same data that is being filled into the corresponding entry of the filling cacheline;
wherein the cache controller is configured to store the same data in both the filling cacheline and in the registers of the buffer system; and
wherein the data in the registers of the buffer system is accessible during a cacheline filling process.

2. The cache system of claim 1, wherein the buffer system is configured such that each register has the same width as the width of the cacheline entries.

3. The cache system of claim 1, wherein the buffer system is configured such that the number of registers is equal to the number of entries of a cacheline.

4. A buffer system for use with a cache system, the buffer system comprising:
a cacheline fill buffer for storing data that is also being filled into a cacheline of the cache system;
means for controlling data writes into the cacheline fill buffer;
means for validating locations within the cacheline fill buffer; and
means for detecting an access hit in the cacheline fill buffer.

5. The buffer system of claim 4, wherein the controlling means determines whether the data to be stored in the cacheline fill buffer is received from a processor or from main memory, the determination based on the validity of the locations within the cacheline fill buffer as established by the validating means.

6. The buffer system of claim 5, wherein the validating means provides validating bits to the controlling means to indicate which one of a plurality of registers in the cacheline fill buffer is currently being filled.

7. The buffer system of claim 6, wherein the validating means further provides offset_valid bits to the controlling means to indicate which registers have already been filled and are valid.

8. The buffer system of claim 4, wherein the cacheline fill buffer, the controlling means, the validating means, and the detecting means comprise logic components.

9. A buffer used in parallel with a cache, the buffer comprising:
a plurality of registers, each register corresponding to an entry in a cacheline that is in the process of being filled, each respective register storing the same data as the corresponding entry in the filling cacheline;
wherein the data in the plurality of registers is accessible when the filling cacheline is invalid.

10. The buffer of claim 9, wherein the plurality of registers are invalidated by a reset bit when the entire cacheline is filled and validated.

11. The buffer of claim 9, wherein each register receives write data from either a processor or main memory depending on the validity of the register.

12. The buffer of claim 11, further comprising a plurality of multiplexers, each multiplexer associated with a respective register, wherein the multiplexers provide the write data to the registers.

13. The buffer of claim 9, further comprising at least one multiplexer for providing requested data stored in one of the registers to a cache controller.

14. The buffer of claim 9, wherein the number of registers is eight and each register is configured to store 32 bits of data.

15. A cache controller comprising:
means for writing data to a cacheline of a cache and writing the same data to a parallel buffer;
means for detecting whether a data access request hits in the cache;
means for accessing data in the cache when a cache hit is detected; and
means for accessing data in the parallel buffer when the data access request hits in a cacheline that is in the process of being filled.

16. The cache controller of claim 15, further comprising:
means for detecting whether the data access request hits in the filling cacheline; and
means for detecting, when the data access request hits in the filling cacheline, whether the data access request hits in a location that has already been filled.

17. A method for controlling a cache system, the method comprising:
beginning a process of filling data in a cacheline and filling the same data in a cacheline fill buffer;
detecting whether or not a data access request hits in cache of the cache system;
when the data access request does not hit in the cache, detecting whether or not the data access request hits in the filling cacheline;
when the data access request hits in the filling cacheline, detecting whether or not the data access request is made for a location in the filling cacheline that has already been filled; and
when the location has already been filled, accessing the data from the cacheline fill buffer.

18. The method of claim 17, wherein, when the data access request does not hit in the filling cacheline, completing the filling of the cacheline and beginning another process of filling a new cacheline and filling the same data into the cacheline fill buffer.

19. The method of claim 17, wherein, when the location has not been filled, continuing filling the cacheline and the cacheline fill buffer until the requested location is filled.
